(19) United States
(12) Patent Application Publication
(10) Pub. No.: US 2015/0371279 A1
(43) Pub. Date: Dec. 24, 2015

(54) METHOD AND SYSTEM FOR TARGETED ADVERTISING ON PRODUCT PACKAGING

(71) Applicant: MasterCard International Incorporated, Purchase, NY (US)

(72) Inventors: Jean-Pierre GERARD, Croton-On-Hudson, NY (US); Arun Elangovan, Astoria, NY (US)

(21) Appl. No.: 14/311,604

(22) Filed: Jun. 23, 2014

(51) Int. Cl. G06Q 30/02

(52) U.S. Cl. CPC G06Q 30/0269

(57) ABSTRACT

A method for customizing product packaging based on consumer behavior includes: reading, by a reading device, payment card data corresponding to a payment card associated with a specific consumer, wherein the payment card data includes at least a specific consumer identifier associated with the specific consumer; transmitting, by a transmitting device, a content request, wherein the content request includes at least a package type associated with a product being purchased and the specific consumer identifier; receiving, by a receiving device, a printable content item, wherein the printable content item is based on at least the package type and consumer behavioral data associated with the specific consumer; and printing, by a printing device, packaging for the product being purchased, wherein the printed packaging is and/or includes the received printable content item and is configured to house the product being purchased.

### FIELD

The present disclosure relates to the customizing of product packaging based on consumer behavior, specifically the use of consumer behavioral data to identify targeted content to be printed on product packaging at the time of sale.

### BACKGROUND

Merchants, manufacturers, retailers, advertisers, content distributors, and other entities are often looking for new ways to reach consumers. As there may be value in reaching a consumer that an entity knows to have conducted a payment transaction, particularly at a specific merchant, some entities have taken to advertising to consumers as part of the purchase experience. For example, advertisements or distributed content may be distributed to the consumer at the point of sale following a transaction, such as by an employee or placed in a bag used to carry the consumer's purchased goods.

However, such advertising and content is often not specific to the consumer, and thus may not be particularly effective. For example, every consumer at a grocery store may receive an advertisement for cosmetics included in their purchase, regardless of their propensity to purchase cosmetics. This can be inefficient, which may result in the expenditure of excess resources and a loss of potential consumers for the advertiser. Furthermore, the use of extra physical media to present advertisements or other contents can be costly for both the advertiser, media producer/distributor, and the environment as a whole. Additionally, the extra physical media is usually placed in the bag or otherwise obscured from view, and requires the consumer to specifically act to view the advertisements (pull them out of the bag and look at them, for instance), which reducing the effectiveness of the advertising.

Thus, there is a need for a technical solution to providing customized product packaging that is targeted to a consumer and that can provide for advertising at the time of a transaction while potentially increasing efficiency and effectiveness.

### SUMMARY

The present disclosure provides a description of systems and methods for customizing product packaging based on consumer behavior.

A method for customizing product packaging based on consumer behavior includes: reading, by a reading device, payment card data corresponding to a payment card associated with a specific consumer, wherein the payment card data includes at least a specific consumer identifier associated with the specific consumer; transmitting, by a transmitting device, a content request, wherein the content request includes at least a package type associated with a product being purchased and the specific consumer identifier; receiving, by a receiving device, a printable content item, wherein the printable content item is based on at least the package type and consumer behavioral data associated with the specific consumer; and printing, by a printing device, packaging for the product being purchased, wherein the printed packaging is and/or includes the received printable content item and is configured to house the product being purchased.

A system for customizing product packaging based on consumer behavior includes a reading device, a transmitting device, a receiving device, and a printing device. The reading device is configured to read payment card data corresponding to a payment card associated with a specific consumer, wherein the payment card data includes at least a specific consumer identifier associated with the specific consumer. The transmitting device is configured to transmit a content request, wherein the content request includes at least a package type associated with a product being purchased and the specific consumer identifier. The receiving device is configured to receive a printable content item, wherein the printable content item is based on at least the package type and consumer behavioral data associated with the specific consumer. The printing device is configured to print packaging for the product being purchased, wherein the printed packaging is and/or includes the received printable content item and is configured to house the product being purchased.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the customizing of product packaging in accordance with exemplary embodiments.

FIG. 2 is a block diagram illustrating the processing server of FIG. 1 for the customizing of product packaging in accordance with exemplary embodiments.

FIGS. 3-5 are flow diagrams illustrating processes for printing of customized product packaging using the system of FIG. 1 in accordance with exemplary embodiments.

FIG. 6 is a flow chart illustrating an exemplary method for customizing product packaging in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Point of Sale—A computer or computer system at a location where a consumer 102 places an order and makes payment for goods and/or services, which may be a register or electronic point of sale in physical locations that the customer visits during the transaction as in “bricks and mortar” stores or virtual in e-commerce environments such as online retailers receiving communications from customers over a network such as the Internet.

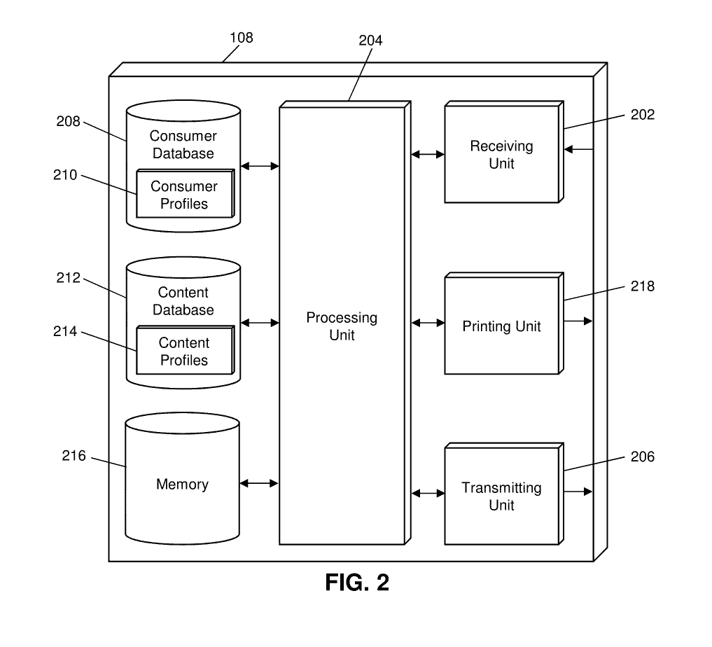

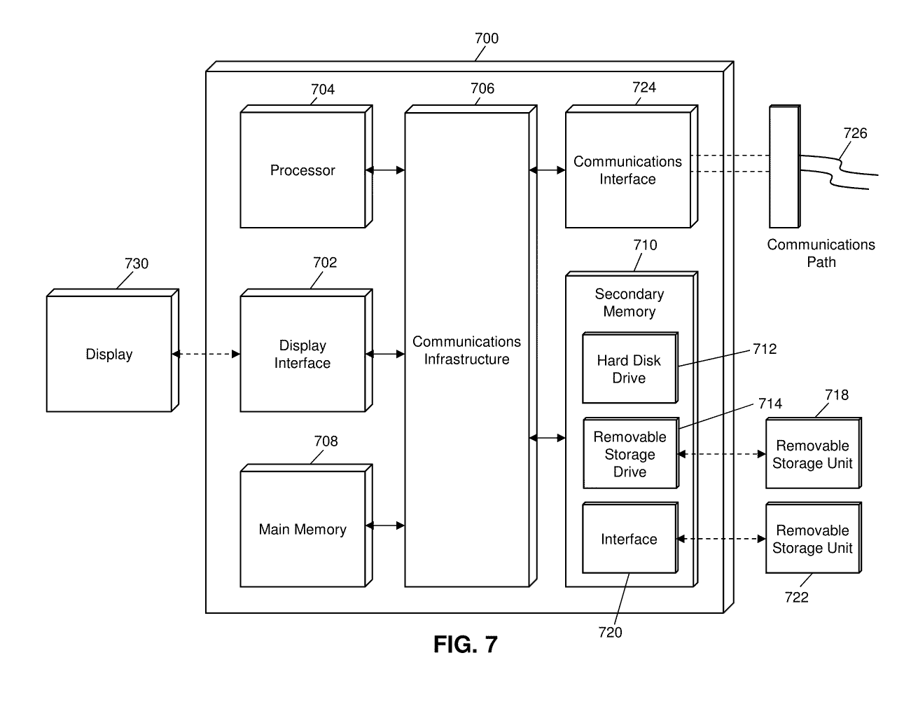

Other than the consumer 102, reference to the point of sale 106, processing server 108, content provider 110 and payment network 112 is reference to the combination of hardware specifically programmed with software to create specialized computer systems, as further explained below with reference to FIGS. 2 and 7, for instance.

### System for Customizing Product Packaging Based on Consumer Behavior

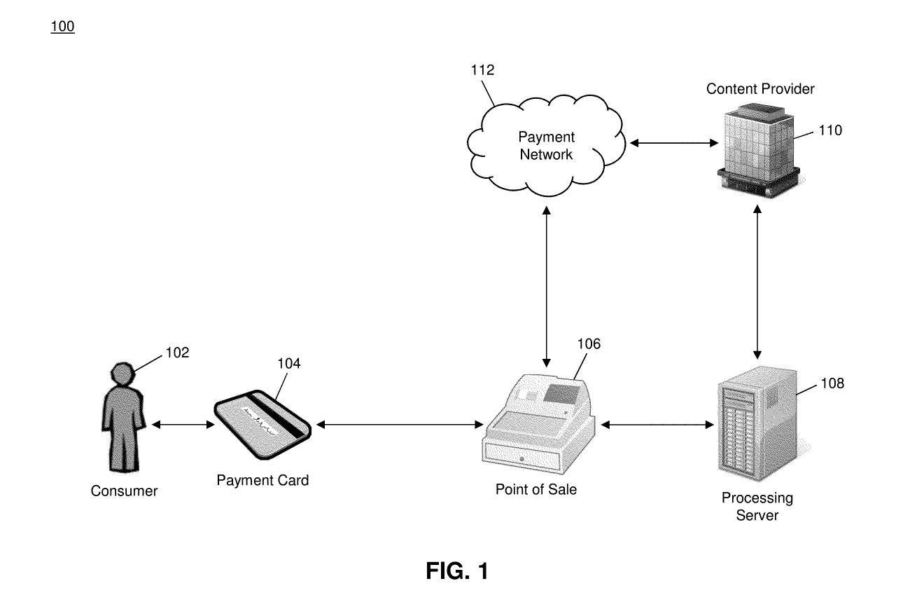

FIG. 1 illustrates a system 100 for the printing of customized product packaging that is customized to a consumer based on consumer behavioral data, such as a consumer's purchasing behavior.

The system 100 may include a consumer 102. The consumer 102 may conduct a payment transaction for the purchase of goods and/or services using a payment card 104, such as a payment card 104 issued to the consumer 102 from a financial institution, such as an issuing bank. The consumer 102 may conduct the payment transaction at a merchant point of sale 106, and may provide the payment card 104 to the point of sale 106 to convey payment details for funding the payment transaction.

The merchant point of sale 106 may read the payment details from the payment card 104 and may initiate processing of the payment transaction using methods and systems that will be apparent to persons having skill in the relevant art. For instance, the point of sale 106 may transmit the payment details and other transaction data (e.g., transaction amount, product data, etc.) to a financial institution associated with the merchant, such as an acquiring bank, who may generate an authorization request for the payment transaction and submit the authorization request to a payment network 112. The payment network 112 may process the payment transaction using methods and systems that will be apparent to persons having skill in the relevant art.

As part of the processing of the payment transaction, the point of sale 106 may provide transaction details to a processing server 108. The processing server 108, discussed in more detail below, may be a part of the same merchant system of the point of sale 106, and, in some embodiments, may be a part of or may comprise the same computing device as the point of sale 106. The processing server 108 may be configured to cause the printing of customized product packaging for one or more products purchased by the consumer 102 as part of the payment transaction.

The processing server 108 may receive an account identifier associated with the payment card 104 from the point of sale 106, such as read from the payment card 104 as part of the receipt of payment details. The account identifier may be, for example, a payment account number for the associated payment account, the name of the consumer 102, or other suitable identifier that will be apparent to persons having skill in the relevant art. The processing server 108 may then request a printable content item from a content provider 110, where the printable content item is identified based on a package type and consumer behavioral data associated with the consumer 102. In an alternative embodiment, the content provider 110 may be configured to cause the printing of customized product packaging for one or more products purchased by the consumer 102 as part of the payment transaction.

The content provider 110 may receive the request from the processing server 108, which may include the account identifier and a package type. The content provider 110 may use the account identifier to identify the consumer 102 (e.g., or an account associated with the consumer 102, such as the payment account associated with the payment card 104), and may identify consumer behavioral data for the identified account. In some embodiments, the consumer behavioral data may be requested from the payment network 112 or other third party entity, such as a data reporting agency, credit bureau, etc. The consumer behavioral data may include purchase behavior, spending behavior, consumer preferences, demographic data, and any other type of data associated with a consumer 102 suitable for performing the functions disclosed herein. By having the processing server 108 and/or payment network involved with providing the customer behavioral data, transaction data from many merchants can be used to develop the customer behavioral data, but in some embodiments, transactions limited to that particular merchant or type of merchant involved with the sale can be utilized.

In some embodiments, the content provider 110 may store the consumer behavioral data. In other embodiments, the processing server 108 may store consumer behavioral data. For example, the merchant system may retain and store data regarding the consumer 102, such as via a consumer loyalty account with the merchant, and may thereby store consumer behavioral data for the consumer 102. For instance, the consumer behavioral data may include the consumer's 102 spending behavior at the merchant, demographic data provided by the consumer 102 (e.g., gender, age, income, zip code, etc.), and consumer-supplied preferences (e.g., interested products, interested industries, preferred types of content, etc.).

The content provider 110 may identify a printable content item based on the consumer behavioral data and the package type. For instance, the content of the printable content item (e.g., the advertisement, offer, etc.) may be based on the consumer behavioral data. For example, a consumer 102 with a high propensity to purchase electronic items may receive an offer for a discounted electronic, while a consumer 102 with a high propensity to purchase new fashion items may receive an advertisement for a recently launched new clothing line. The type of content item that is identified may be based on the package type. For example, a larger image for printing may be identified for large boxes, while a smaller image may be identified for plastic bags. The content item may be a graphic, image, two-dimensional model, three-dimensional model, or any other suitable type of content item as will be apparent to persons having skill in the relevant art. The content may be stored at the content provider 110, at the merchant or point of sale 106, processing server 108, or at a separate third party.

In some instances, the processing server 108 may store the content item or items to be identified. For example, the processing server 108 may store various graphics for printing on product packaging for advertisements or coupons for items carried by the merchant. In such an example, the processing server 108 may identify the consumer 102, identify the consumer's 102 behavioral profile, and identify the printable content item.

Once a printable content item has been identified, the processing server 108 may cause the print packaging for the product to be purchased at the point of sale or other location where the package is being used, which may be comprised of or may include the printable content item. For example, if the content item is a graphic, the processing server 108 may print the graphic on a surface or a label to be applied to the surface of the box, bag, container, etc. used to carry or ship the product. In another example, if the content item is a three-dimensional model, the processing server 108 may print the model (e.g., using a three-dimensional printer), which may be used to store and/or ship the product.

Once the packaging has been produced, the consumer 102 may receive the transacted-for product in the customized packaging that includes content customized to that consumer 102 and their behavioral data. By identifying content that is tailored to a specific consumer 102, the processing server 108 may provide for more effective advertising and content distribution than traditional methods, which may increase efficiency and revenue for an entity while decreasing expense. In addition, by using product packaging for the distribution of content via printing, the processing server 108 may be able to provide for more effective and more easily noticed and viewable advertising and other content distribution for a lower resource cost, which may lower expenses for all parties involved, as well as possibly have a positive effect on the environment due to a decrease in waste, depending on implementation.

### Processing Server

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 700 illustrated in FIG. 7 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive an account identifier from the point of sale 106, or read from the payment card 104 using methods and systems that will be apparent to persons having skill in the relevant art. The receiving unit 202 may also be configured to receive printable content items, such as from the content provider 110. The receiving unit 202 may also receive package type information, such as via an input device or from the point of sale 106. For example, the point of sale 106 may identify a package type for a product when the product data is entered into the point of sale 106, and may transmit the package type to the processing server 108 to be received by the receiving unit 202.

The processing server 108 may further include a processing unit 204. The processing unit 204 may be configured to perform the functions of the processing server 108 discussed herein as will be apparent to persons having skill in the relevant art. The processing unit 204 may be configured to identify data received from the receiving unit 202, such as the account identifier, and process the data accordingly. For instance, when an account identifier is received, the processing unit 204 may generate a request for a printable content item including a package type and the account identifier, which it may provide to a transmitting unit 206 for transmitting.

The transmitting unit 206 may be configured to transmit data over one or more networks via one or more network protocols. The transmitting unit 206 may transmit requests for printable content items to the content provider 110. In some embodiments, the transmitting unit 206 may be configured to transmit a request for consumer behavioral data, such as to the payment network 112 or other third party entity. In such an embodiment, the receiving unit 202 may receive consumer behavioral data in response to the transmitting request. The transmitting unit 206 may then transmit the consumer behavioral data to the content provider 110 in a request for a printable content item.

The processing server 108 may further include a printing unit 218. The printing unit 218 may be configured to print, or to instruct a separate printing device at the point of sale 106 or other location to print, product packaging that is comprised of or includes a received printable content item. In addition to the selected content, other data items such as the merchant logo, name or other information specific to the consumer making the purchase (e.g., name, delivery address, etc.) or specific to the products contained therein (e.g., list of contents, instructions regarding the contents, etc.), machine readable codes providing links to other resources, and/or aesthetic designs may be printed on the package as well. Methods and systems for printing content items, such as graphics, images, or two- or three-dimensional models, will be apparent to persons having skill in the relevant art.

The processing server 108 may also include a memory 216. The memory 216 may be configured to store data suitable for performing the functions disclosed herein as will be apparent to persons having skill in the relevant art. For instance, the memory 216 may store data regarding generating requests for content items, for rendering received content items, for communicating with printing devices, rules for identifying consumer profiles or behavioral data, rules for identifying content, and other data that will be apparent to persons having skill in the relevant art.

In some embodiments, the processing server 108 may also include a consumer database 208. The consumer database 208 may be configured to store a plurality of consumer profiles 210. Each consumer profile 210 may include data related to a consumer 102 and include at least a consumer identifier and consumer behavioral data. The consumer identifier may be an account identifier or any other suitable value used for identification of the respective consumer profile 210 and/or related consumer 102. For example, the consumer identifier may be a payment account number, name, username, e-mail address, phone number, street address, identification number, etc.

The consumer behavioral data may be, as discussed above, data associated with the related consumer 102 that may be suitable for use in identifying content items personalized to the consumer 102. For example, the consumer behavioral data may include consumer spending behavior, consumer purchase behavior, consumer preferences, consumer demographic data, loyalty data, previous content distribution data, consumer feedback data, and other data that will be apparent to persons having skill in the relevant art.

In embodiments where the processing server 108 includes the consumer database 208, the processing unit 204 may be configured to identify a consumer profile 210 based on the account identifier received by the receiving unit 202. In such an embodiment, the processing unit 204 may generate a content request that includes the consumer behavioral data, for transmitting to the content provider 110 via the transmitting unit 206.

In some embodiments, the processing server 108 may further include a content database 212. The content database 212 may be configured to store a plurality of content profiles 214. Each content profile 214 may include data related to a printable content item including at least one or more selection criteria. The one or more selection criteria may be criteria used for the identification of a content item for printing, and may include one or more spending or purchase behaviors, demographics, preferences, product data, or any other suitable type of criteria that will be apparent to persons having skill in the relevant art.

In embodiments where the processing server 108 includes the content database 212, the processing unit 204 may be configured to identify a content profile 210 for printing. In such an embodiment, the processing unit 204 may identify a content profile 210 based on correspondence between the included selection criteria and the consumer behavioral profile of the identified consumer profile 210. Methods for the identification of a content item based on a consumer behavioral profile will be apparent to persons having skill in the relevant art. The processing unit 204 may then provide the related printable content item to the printing unit 218 for printing of the product packaging.

### Processes for Customizing Product Packaging Based on Consumer Behavior

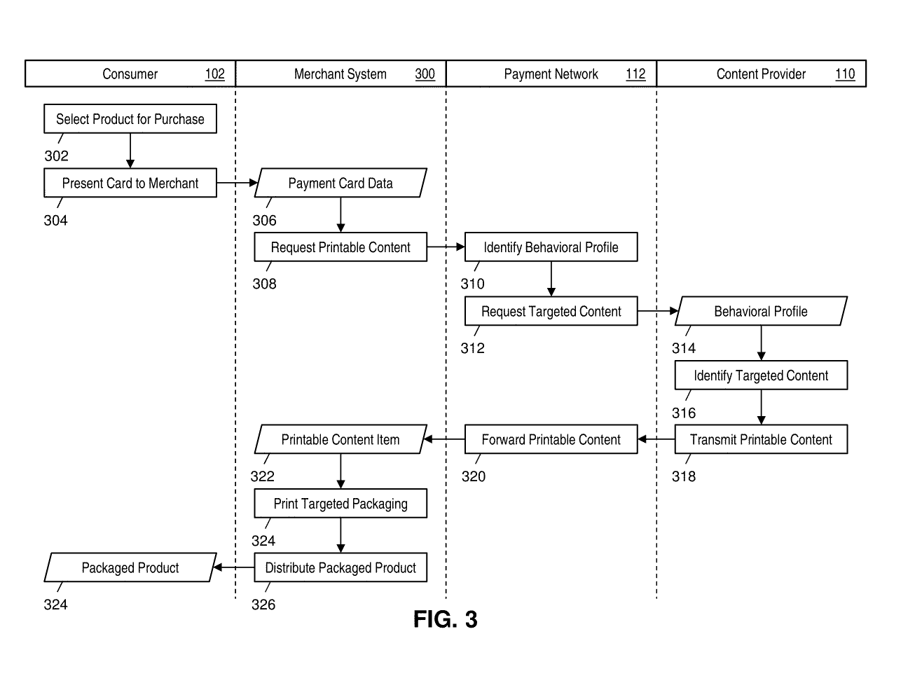

FIG. 3 illustrates a process for the printing of customized product packaging based on consumer behavior using the processing server 108, the payment network 112, and the content provider 110 of the system 100 of FIG. 1.

In step 302, the consumer 102 may select a product to purchase from the merchant. In step 304, the consumer 102 may provide their payment card 104 to the merchant point of sale 106 for payment of the selected product. In step 306, the merchant system 300, which may include the point of sale 106 and/or processing server 108, may read the payment card data encoded on the payment card 104. The payment card data may include at least an account identifier corresponding to a payment account and/or the consumer 102 associated with the payment card 104.

In step 308, the merchant system 300 (e.g., the transmitting unit 206 of the processing server 108) may transmit a request for printable content to the payment network 112. The request for printable content may include at least the account identifier and a package type. The package type may be based on the selected product for purchase, and may be identified as part of the traditional processing of the payment transaction (e.g., upon scanning in of the product in the point of sale 106). In step 310, the payment network 112 may identify a consumer behavioral profile for the consumer 102 based on the account identifier.

In step 312, the payment network 112 may transmit a request for a targeted content item to the content provider 110. In step 314, the content provider 110 may receive the request, which may include the consumer behavioral profile that was identified and the package type. In step 316, the content provider 110 may identify a targeted printable content item based on the consumer behavioral profile and package type. In step 318, the content provider 110 may transmit the identified printable content item to the payment network 112 in response to the received request. In step 320, the payment network 112 may forward the received content item to the merchant system 300.

In step 322, the merchant system 300 (e.g., the receiving unit 202 of the processing server 108) may receive the targeted printable content item. In step 324, the merchant system 300 (e.g., the printing unit 218 of the processing server 108) may print the packaging for the product that is comprised of or otherwise includes the received targeted printable content item. In step 326, the customized, targeted packaging may be distributed to the consumer 102 using traditional methods. For example, an employee of the merchant may hand the packaging to the consumer 102, the package may be shipped to the consumer 102, etc. In step 324, the consumer 102 may receive the customized package with their purchased product included therein.

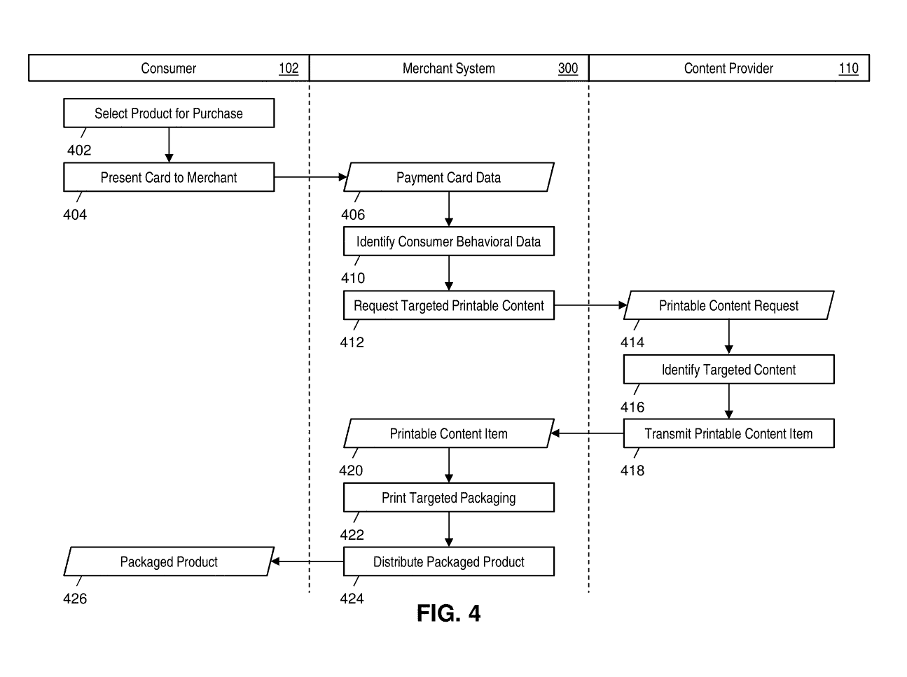

FIG. 4 illustrates an alternative process for the printing of customized product packaging based on consumer behavior using the processing server 108 and the content provider 110 of the system 100 of FIG. 1.

In step 402, the consumer 102 may select a product to purchase from the merchant. In step 404, the consumer 102 may provide their payment card 104 to the merchant point of sale 106 for payment of the selected product. In step 406, the merchant system 300 may read the payment card data encoded on the payment card 104 or receive it from a remote customer 102. The payment card data may include at least an account identifier corresponding to a payment account and/or the consumer 102 associated with the payment card 104.

In step 408, the merchant system 300 (e.g., the processing unit 204 of the processing server 108) may identify consumer behavioral data for the consumer 102. Identification of the consumer behavioral data may include identifying a consumer profile 210 that includes the read account identifier, and identifying the consumer behavioral data included therein. In step 412, the merchant system 300 (e.g., the transmitting unit 206 of the processing server 108) may transmit a request for printable content to the content provider 110 that includes the identified consumer behavioral data and a package type for the product being purchased.

In step 414, the content provider 110 may receive the request, which may include the consumer behavioral data that was identified and the package type. In step 416, the content provider 110 may identify a targeted printable content item based on the consumer behavioral profile and package type. In step 418, the content provider 110 may transmit the identified printable content item to the merchant system 300 in response to the received request.

In step 420, the merchant system 300 (e.g., the receiving unit 202 of the processing server 108) may receive the targeted printable content item. In step 422, the merchant system 300 (e.g., the printing unit 218 controlled by or provided content from the processing server 108) may print the packaging for the product that is comprised of or otherwise includes the received targeted printable content item. In step 424, the customized, targeted packaging may be distributed to the consumer 102 using traditional methods. For example, an employee of the merchant may hand the packaging to the consumer 102, the package may be shipped to the consumer 102, etc. In step 426, the consumer 102 may receive the customized package with their purchased product included therein.

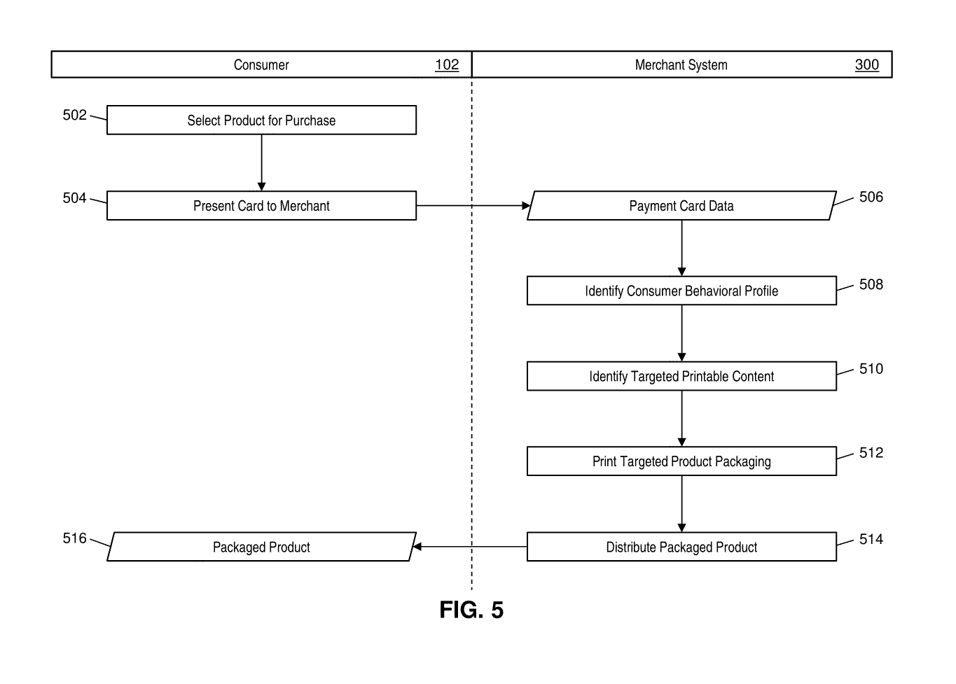

FIG. 5 illustrates another alternative process for the printing of customized product packaging based on consumer behavior using the processing server 108 of the system 100 of FIG. 1.

In step 502, the consumer 102 may select a product to purchase from the merchant. In step 504, the consumer 102 may provide their payment card 104 to the merchant point of sale 106 for payment of the selected product. In step 506, the merchant system 300 may read or otherwise receive the payment card data encoded on the payment card 104. The payment card data may include at least an account identifier corresponding to a payment account and/or the consumer 102 associated with the payment card 104.

In step 508, the merchant system 300 (e.g., the processing unit 204 of the processing server 108) may identify consumer behavioral data for the consumer 102. Identification of the consumer behavioral data may include identifying a consumer profile 210 that includes the read account identifier, and identifying the consumer behavioral data included therein. In step 510, the merchant system 300 (e.g., the processing unit 204) may identify a printable content item. Identification of the printable content item may include identifying a content profile 214 stored in the content database 212 based on a correspondence between the included one or more selection criteria and the identified consumer behavioral data. The identified printable content item may also be selected based on a package type for the product being purchased.

In some embodiments, the content profiles 214 may include one or more model scores based on the included one or more selection criteria. Each model score may be based on a consumer spending model, such as a consumer's 102 propensity to spend in a related category (e.g., merchant, industry, product, etc.). In such an embodiment, the processing unit 204 of the processing server 108 may be configured to calculate corresponding consumer scores for each consumer profile 210 based on the consumer behavioral data included therein. In such an instance, identifying the printable content item may include identifying a specific content profile 214 based on correspondence between the included model score and the corresponding consumer score and identifying the related printable content item.

In step 512, the merchant system 300 (e.g., the printing unit 218 of the processing server 108) may print the packaging for the product that is comprised of or otherwise includes the received targeted printable content item. In step 514, the customized, targeted packaging may be distributed to the consumer 102 using traditional methods. For example, an employee of the merchant may hand the packaging to the consumer 102, the package may be shipped to the consumer 102, etc. In step 516, the consumer 102 may receive the customized package with their purchased product included therein.

### Exemplary Method for Customizing Product Packaging Based on Consumer Behavior

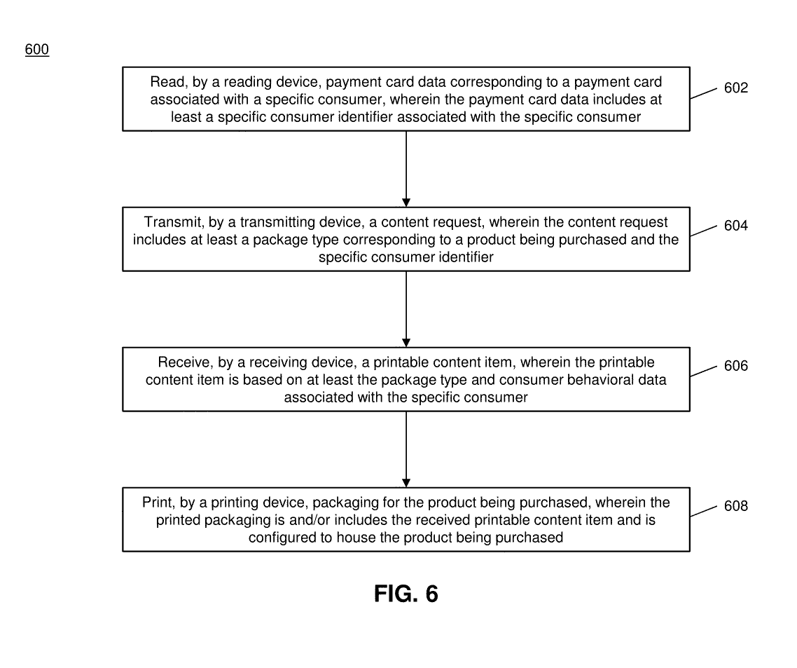

FIG. 6 illustrates a method 600 for customizing printed product packaging based on consumer behavioral data at the point of sale.

In step 602, payment card data corresponding to a payment card (e.g., the payment card 104) associated with a specific consumer (e.g., the consumer 102) may be read by a reading device (e.g., the point of sale 106, receiving unit 202, etc.), wherein the payment card data includes at least a specific consumer identifier associated with the specific consumer 102. In step 604, a content request may be transmitted by a transmitting device (e.g., the transmitting unit 206), wherein the content request includes at least a package type corresponding to a product being purchased and the specific consumer identifier.

In step 606, a printable content item may be received by a receiving device (e.g., the receiving unit 202), wherein the printable content item is based on at least the package type and consumer behavioral data associated with the specific consumer 102. In some embodiments, the printable content item may be at least one of: a graphic, an image, a two-dimensional model, and a three-dimensional model. In one embodiment, the printable content item may be a data file. In some embodiments, the printable content item may include at least one of: an offer, advertisement, discount, coupon, deal, or reward, or the like. In one embodiment, the received printable content item may be further based on at least one of: the product being purchased and a merchant associated with the product being purchased. In some embodiments, the consumer behavioral data may include at least one of: transaction data, demographic data, advertising data, offer data, and consumer-supplied data.

In step 608, packaging for the product to be purchased may be printed by a printing device (e.g., the printing unit 218), wherein the printed packaging is and/or includes the received printable content item and is configured to house the product being purchased.

In one embodiment, the method 600 may further include: storing, in a consumer database (e.g., the consumer database 208), a plurality of consumer profiles (e.g., consumer profiles 210), wherein each consumer profile 210 includes data related to a consumer 102 including at least a consumer identifier and consumer behavioral data; and identifying, in the consumer database 208, a specific consumer profile 210 where the included consumer identifier corresponds to the specific consumer identifier, and wherein the transmitting content request further includes the consumer behavioral data included in the identified specific consumer profile.

In a further embodiment, the method 600 may even further include: storing, in a content database (e.g., the content database 212), a plurality of content profiles (e.g., the content profiles 214), wherein each content profile 214 includes data related to a printable content item including at least one or more selection criteria; and identifying, in the content database 212, a specific content profile 214 based on a correspondence between the included one or more selection criteria and the consumer behavioral data included in the identified specific consumer profile 210, wherein the received printable content item is the printable content item included in the identified specific content profile 214.

In an even further embodiment, transmitting the content request may include transmitting the content request from a first module in a computing device (e.g., the processing server 108) to a second module in the computing device 108, and receiving the printable content item may include receiving the printable content item at the first module in the computing device 108 from the second module in the computing device 108. In another even further embodiment, the one or more selection criteria may include at least one model score, and identifying the specific content profile 214 may include: identifying, based on at least the consumer behavioral data included in the specific consumer profile 210, a consumer score; and identifying, by a processing device (e.g., the processing unit 204), the specific content profile 214 based on a correspondence between the included at least one model score and the identified consumer score.

### Computer System Architecture

FIG. 7 illustrates a computer system 700 in which embodiments of the present disclosure, or portions thereof, may be implemented as computer-readable code. For example, the processing server 108 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for customizing product packaging based on consumer behavioral data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for customizing product packaging based on consumer behavior, comprising:
reading, by a reading device, payment card data corresponding to a payment card associated with a specific consumer, wherein the payment card data includes at least a specific consumer identifier associated with the specific consumer;
transmitting, by a transmitting device, a content request, wherein the content request includes at least a package type associated with a product being purchased and the specific consumer identifier;
receiving, by a receiving device, a printable content item, wherein the printable content item is based on at least the package type and consumer behavioral data associated with the specific consumer; and
printing, by a printing device, packaging for the product being purchased, wherein the printed packaging is and/or includes the received printable content item and is configured to house the product being purchased.

2. The method of claim 1, wherein the printable content item is at least one of: a graphic, an image, a two-dimensional model, and a three-dimensional model.

3. The method of claim 1, wherein the printable content item is a data file.

4. The method of claim 1, wherein the printable content item includes at least one of: an offer, advertisement, discount, coupon, deal, or reward.

5. The method of claim 1, further comprising:
storing, in a consumer database, a plurality of consumer profiles, wherein each consumer profile includes data related to a consumer including at least a consumer identifier and consumer behavioral data; and
identifying, in the consumer database, a specific consumer profile where the included consumer identifier corresponds to the specific consumer identifier, wherein
the transmitted content request further includes the consumer behavioral data included in the identified specific consumer profile.

6. The method of claim 5, further comprising:
storing, in a content database, a plurality of content profiles, wherein each content profile includes data related to a printable content item including at least one or more selection criteria; and
identifying, in the content database, a specific content profile based on a correspondence between the included one or more selection criteria and the consumer behavioral data included in the identified specific consumer profile, wherein
the received printable content item is the printable content item included in the identified specific content profile.

7. The method of claim 6, wherein
transmitting the content request includes transmitting the content request from a first module in a computing device to a second module in the computing device, and
receiving the printable content item includes receiving the printable content item at the first module in the computing device from the second module in the computing device.

8. The method of claim 6, wherein the one or more selection criteria includes at least one model score, and identifying the specific content profile further includes:
identifying, based on at least the consumer behavioral data included in the specific consumer profile, a consumer score, and
identifying, by a processing device, the specific content profile based on a correspondence between the included at least one model score and the identified consumer score.

9. The method of claim 1, wherein the received printable content item is further based on at least one of: the product being purchased and a merchant associated with the product being purchased.

10. The method of claim 1, wherein the consumer behavioral data includes at least one of: transaction data, demographic data, advertising data, offer data, and consumer-supplied data.

11. A system for customizing product packaging based on consumer behavior, comprising:
a reading device configured to read payment card data corresponding to a payment card associated with a specific consumer, wherein the payment card data includes at least a specific consumer identifier associated with the specific consumer;
a transmitting device configured to transmit a content request, wherein the content request includes at least a package type associated with a product being purchased and the specific consumer identifier;
a receiving device configured to receive a printable content item, wherein the printable content item is based on at least the package type and consumer behavioral data associated with the specific consumer; and
a printing device configured to print packaging for the product being purchased, wherein the printed packaging is and/or includes the received printable content item and is configured to house the product being purchased.

12. The system of claim 11, wherein the printable content item is at least one of: a graphic, an image, a two-dimensional model, and a three-dimensional model.

13. The system of claim 11, wherein the printable content item is a data file.

14. The system of claim 11, wherein the printable content item includes at least one of: an offer, advertisement, discount, coupon, deal, or reward.

15. The system of claim 11, further comprising:
a consumer database configured to store a plurality of consumer profiles, wherein each consumer profile includes data related to a consumer including at least a consumer identifier and consumer behavioral data; and
a processing device configured to identify, in the consumer database, a specific consumer profile where the included consumer identifier corresponds to the specific consumer identifier, wherein
the transmitted content request further includes the consumer behavioral data included in the identified specific consumer profile.

16. The system of claim 15, further comprising:
a content database configured to store a plurality of content profiles, wherein each content profile includes data related to a printable content item including at least one or more selection criteria, wherein
the processing device is further configured to identify, in the content database, a specific content profile based on a correspondence between the included one or more selection criteria and the consumer behavioral data included in the identified specific consumer profile, and
the received printable content item is the printable content item included in the identified specific content profile.

17. The system of claim 16, wherein
transmitting the content request includes transmitting the content request from a first module in a computing device to a second module in the computing device, and
receiving the printable content item includes receiving the printable content item at the first module in the computing device from the second module in the computing device.

18. The system of claim 16, wherein the one or more selection criteria includes at least one model score, and identifying the specific content profile further includes:
identifying, based on at least the consumer behavioral data included in the specific consumer profile, a consumer score, and
identifying, by a processing device, the specific content profile based on a correspondence between the included at least one model score and the identified consumer score.

19. The system of claim 11, wherein the received printable content item is further based on at least one of: the product being purchased and a merchant associated with the product being purchased.

20. The system of claim 11, wherein the consumer behavioral data includes at least one of: transaction data, demographic data, advertising data, offer data, and consumer-supplied data.
